(19) United States
(12) Patent Application Publication
(10) Pub. No.: US 2022/0374966 A1
(43) Pub. Date: Nov. 24, 2022

(54) SYSTEM AND METHOD FOR AGGREGATION OF LOCAL BUSINESS INVENTORIES

(71) Applicant: Elliott Saint-Pierre, View Park, CA (US)

(72) Inventor: Elliott Saint-Pierre, View Park, CA (US)

(21) Appl. No.: 17/328,343

(22) Filed: May 24, 2021

(51) Int. Cl. G06Q 30/06; G06Q 10/08

(52) U.S. Cl. CPC G06Q 30/0641; G06Q 30/0603; G06Q 30/0633; G06Q 30/0639; G06Q 10/087

(57) ABSTRACT

A system and method for aggregation of local business inventories is provided. In some embodiments, the system may comprise a computing device associated with a customer and one or more computing devices associated with one or more local businesses, such as those that provide goods, services, or even, rental of goods. The local business computing devices may receive inventory input from the one or more businesses, wherein the inventory input is associated with one or more products or one or more service hours available at the one or more local businesses. The business computing device may also update the inventory input based on an availability change of the one or more products or the one or more service hours. The local business computing devices may then generate and transmit inventory output based on the inventory input. The computing device associated with the customer may receive the inventory output from the one or more computing devices associated with the one or more local businesses. The customer computing device may receive a product query or a service query from the customer and then filter and display the inventory output based on the product query or the service query, and distance from or transit time to the one or more local businesses.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to systems and methods for querying product inventories and, more particularly, to a system and method for aggregation of local business inventories so as to provide a customer with the most convenient and efficient means of procuring a desired product.

### BACKGROUND

In-person shopping is time-consuming, inefficient, often times, unsuccessful. As a result, in-person shopping is not always realistic for the busy individual. This reality is due to a number of factors, including driving and parking time, and the time it takes to search one or more entire stores for a particular item, which may or may not be sold or in stock at a nearby location.

The advent of online shopping has helped to mitigate some of these concerns but still comes with its own drawbacks. In particular, one might require an item more imminently than online shopping provides for, such as a final recipe ingredient, a house project, or a host/hostess gift. To that end, some retail store websites will list local inventories so as to provide an in-person pick-up option. However, these inventories are not always regularly updated and often times, do not reflect the local store's actual inventory.

Online retailers, such as Amazon, are aimed at solving this problem by offering same-day, next-day or other short-term delivery options. Even with these speedy delivery practices, not all desired products are available on this website. Moreover, it provide individuals with the ability to see, feel, and examine the goods prior to purchase. As a result, there exists a need for a comparison of numerous local stores' inventories and prices.

### SUMMARY

The present disclosure is directed to a system and method for aggregation product inventories of local businesses, which allows consumers to price compare and efficiently obtain goods that are needed or desired. A local business inventory aggregation system is provided that may utilize one or more computing devices associated with one or more local businesses (alternatively, the “local business computing devices” or the “business computing devices”) and a computing device associated with a customer (alternatively, the “customer computing device”).

In many embodiments, and for purposes of brevity, system and method for aggregation of local business product inventories is shown and described. However, it will be understood that the local businesses may include virtually any type of business, including those that provide services rather than goods. In other embodiments, the local businesses may even provide rental, rather than purchase, of goods. Moreover, in some embodiments, the customer may be an individual or another business for which the order is intended. Further, the customer may be a third party, such as a third-party delivery service, which may retrieve the product(s) and subsequently deliver the product(s) to the individual for whom it is ultimately intended. For purposes of brevity, each of the aforementioned recipients of the product(s) will hereafter be referred to as the “customer.”

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the system for aggregation of local business inventories may comprise the local business computing devices and the customer computing device. The one or more computing devices associated with the one or more local businesses may be operative to receive inventory input from the one or more local businesses. The inventory input may be associated with one or more products available at the one or more local businesses. In other embodiments wherein the business may provide services rather than products, the inventory input may be associated with one or more service hours.

In certain embodiments, the inventory input may comprise a specified amount or an estimated amount of the one or more products or the one or more service hours available at each of the one or more local businesses. Indeed, in some embodiments, the estimated amount may be based on previous sales, including the number of the one or more products sold on that particular day. Alternatively, the estimated amount may be based on a season (and concomitant demand for one or more of the one or more products during that season).

In some embodiments, the customer computing device may be operative to track and update a business reliability score. For instance, the customer may manually input an availability score based on whether the one or more products or the one or more service hours, or even the specified amount, were indeed available at the one or more local businesses. The business reliability score may then be updated based on the availability score. The customer computing device may also be operative to filter the one or more products or the one or more service hours from the one or more local businesses based on the business reliability score.

Further, the local business computing devices may be operative to track the business reliability score based on the specified amount of the one or more products or the one or more service hours available at each of the one or more local businesses. The business reliability score may be updated in response to the one or more local businesses accurately updating the specified amount. For instance, if the one or more local businesses consistently update the specified amount in an accurate manner, the business reliability score may be higher. On the other hand, if the one or more local businesses consistently update the specified amount in an inaccurate manner, or even fail to consistently update the specified amount at all, the business reliability score may be lower.

The local business computing devices may also be operative to update the inventory input based on an availability change of the one or more products or the one or more service hours. The availability change may correspond to another customer purchasing one or more of the one or more products or the one or more service hours. The local business computing devices may then be operative to generate and transmit inventory output based on the inventory input.

The computing device associated with the customer may be operative to receive the inventory output from the local business computing devices. The customer computing device may also be operative to receive a product query or a service query from the customer. The product query may correspond to one or more products needed or desired by the customer. The service query may correspond to one or more services needed or desired by the customer.

In alternative embodiments, the customer computing device may be operative to generate and display one or more similar products based on one or more customer preferences or one or more anticipated product queries. The one or more customer preferences may be set by the customer or may be automatically generated based on the customer's previous product queries. Similarly, the one or more anticipated product queries may be based on the customer's previous product queries. In further embodiments, the customer computing device may be operative to display a menu comprising all available products at one or more of the one or more local businesses.

The customer computing device may then be operative to filter and display the inventory output based on the product query or the service query, and distance from or transit time to the one or more local businesses. In some embodiments, the customer may be able to select whether to filter the inventory output based on either the distance from the one or more local businesses or the transit time to the one or more local businesses. For instance, the transit time may be more informative in certain circumstances, such as, for example and not limitation, where traffic patterns vary. In embodiments wherein the inventory output comprises the estimated amount, the customer computing device may be operative to display the inventory output if the estimated amount is greater than a predetermined threshold.

According to some embodiments, the one or more computing devices associated with the one or more local businesses may be further operative to receive a position input based on a position of the one or more products within the one or more local businesses, and generate and transmit position output based on the position input. In such embodiments, the computing device associated with the customer may be further operative to receive and display the position output. In this manner, the customer may expeditiously retrieve the one or more products within the local business.

In further embodiments, the customer computing device may also be operative to receive one or more product reservations comprising at least one of the one or more products at the one or more local businesses. The customer computing device may then be operative to receive identity information and payment information associated with the customer, and transmit the one or more product reservations, payment information, and identity information.

In these embodiments, the business computing devices may be operative to receive the one or more product reservations, the identity information, and the payment information and notify the one or more local businesses of the one or more product reservations, the payment information, and the identity information. Then, the local business computing devices may be operative to receive a fulfillment input from the one or more local businesses indicating the one or more products have been reserved for the customer. In additional embodiments, the local business computing devices may also be operative to receive an unavailability input from the one or more local businesses indicating the one or more products is unavailable.

In embodiments where the local business computing devices may receive the unavailability input, the local business computing devices may be further operative to generate and transmit an unavailability output based on the unavailability input. The customer computing device may then be operative to receive the unavailability output and notify the customer of the unavailability output. The computing device associated with the customer may be further operative to then display one or more alternative products available at one or more of the one or more local businesses. The one or more alternative products may comprise a different brand or a different product which serves the same purpose.

In some embodiments where the customer computing device may be operative to receive and transmit the one or more product reservations, the customer computing device may also be operative to track and update a customer reliability score. The customer reliability score may be based on whether the customer reliably and consistently shows up to retrieve the one or more products from the one or more local businesses within an allotted time frame after making the one or more product reservations.

The local business computing devices may be operative to track the customer reliability score. In some embodiments, the one or more local businesses may manually input a reservation score based on whether the customer retrieved the one or more products reserved under the one or more product reservations. The customer reliability score may then be updated based on the reservation score. The local business computing devices may also be operative to receive the customer reliability score.

According to further embodiments, the local business computing devices may be further operative to receive a demand input. The demand input may correspond to an increased demand for one or more of the one or more products or the one or more service hours. In such embodiments, the local business computing devices may also be operative to generate and transmit a demand notification to the one or more local businesses. In this manner, the one or more local businesses may then become aware of the increased demand and increase production of the one or more products, hire additional employees or contractors for the one or more services, or otherwise act accordingly.

In still additional embodiments, the local business computing devices may be operative to dynamically price the one or more products or the one or more service hours. In some of such embodiments, dynamically pricing the one or more products may be based on the local business desiring to sell the one or more products sooner. In other embodiments, dynamically pricing the one or more products may be based on an expiration date of the one or more products. Further, dynamically pricing the one or more service hours may be based on one or more upcoming, available service hours which the local business desires to fill.

In one embodiment of the present invention, a computer-implemented method may be used to facilitate aggregation of the local business inventories for the customer using the customer computing device. The method may comprise the steps of: providing one or more computing devices associated with one or more local businesses and a computing device associated with a customer; receiving, at the one or more computing devices associated with the one or more local businesses, inventory input from the one or more local businesses, wherein the inventory input is associated with one or more products or one or more service hours available at the one or more local businesses; updating, at the one or more computing devices associated with the one or more local businesses, the inventory input based on an availability change of the one or more products or the one or more service hours; generating and transmitting, at the one or more computing devices associated with the one or more local businesses, inventory output based on the inventory input; receiving, at the computing device associated with the customer, the inventory output from the one or more computing devices associated with the one or more local businesses; receiving, at the computing device associated with the customer, a product query or a service query from the customer; and filtering and displaying, at the computing device associated with the customer, the inventory output based on the product query or the service query and distance from or transit time to the one or more local businesses.

In some embodiments, the computer-implemented method may further comprise the step of: displaying, at the computing device associated with the customer, a menu comprising all available products at one or more of the one or more local businesses. This step may be useful if the customer has not yet selected a specific product but rather, desires to browse the local business' entire inventory of products. Additionally, the method may further comprise the step of: generating and displaying, at the computing device associated with the customer, one or more similar products based on one or more customer preferences or one or more anticipated product queries.

In additional embodiments, the method may comprise the further steps of: receiving, at the one or more computing devices associated with the one or more local businesses, a position input based on a position of the one or more products within the one or more local businesses; generating and transmitting, at the one or more computing devices associated with the one or more local businesses, position output based on the position input; and receiving and displaying, at the computing device associated with the customer, the position output. These further steps may further expedite the customer's retrieval of the one or more products within the local business.

According to further embodiments, the computer-implemented method may further comprise the steps of: receiving, at the computing device associated with the customer, one or more product reservations comprising at least one of the one or more products at the one or more local businesses; receiving, at the computing device associated with the customer, identity information and payment information associated with the customer; transmitting, at the computing device associated with the customer, the one or more product reservations, payment information, and identity information; receiving, at the one or more computing devices associated with the one or more local businesses, the one or more product reservations; notifying, at the one or more computing devices associated with the one or more local businesses, the one or more local businesses of the one or more product reservations; and receiving, at the one or more computing devices associated with the one or more local businesses, a fulfillment input from the one or more local businesses indicating the one or more products have been reserved for the customer.

In embodiments where the one or more products may be unavailable at the local business after the computing device associated with the customer has received the one or more product reservations, the method may alternatively comprise the steps of: receiving, at the one or more computing devices associated with the one or more local businesses, an unavailability input from the one or more local businesses indicating the one or more products is unavailable; generating and transmitting, at the one or more computing devices associated with the one or more local businesses, an unavailability output based on the unavailability input; receiving, at the computing device associated with the customer, the unavailability output; notifying, at the computing device associated with the customer, the customer of the unavailability output; and displaying, at the computing device associated with the customer, one or more alternative products available at one or more of the one or more local businesses.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows an embodiment of the system for aggregation of local business inventories.

FIG. 2 shows an embodiment of the system for aggregation of local business inventories.

FIG. 3 shows an embodiment of the system for aggregation of local business inventories.

FIG. 4 is a flowchart illustrating the method for aggregation of local business inventories.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A system and method is provided that, in some embodiments, may facilitate a customer's retrieval of one or more products from one or more local businesses, thereby increasing shopping efficiency and convenience. The system and method may involve any local business which may provide goods, services, or event rental of goods. However, throughout this disclosure, the term “local business” or “business” will be described as offering one or more products.

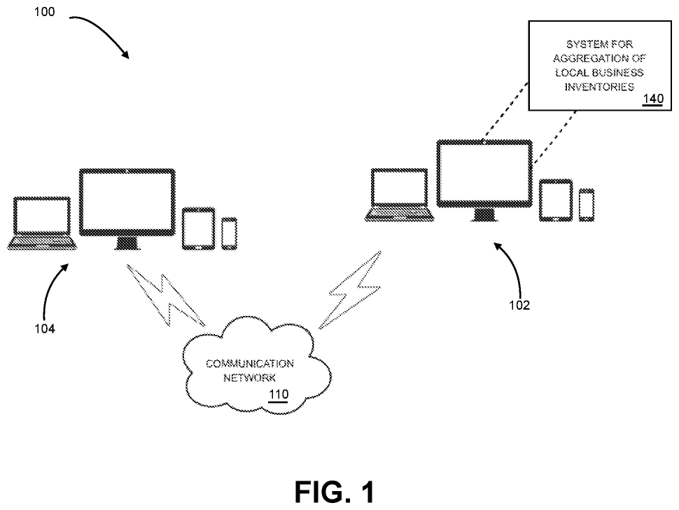

FIG. 1 is illustrative of a networked environment 100 in which an embodiment of a system for aggregation of local business inventories is implemented. As shown in FIG. 1, system 140 may comprise one or more computing devices associated with one or more local businesses 102 (alternatively, “local business computing devices” or “business computing devices”) and a computing device associated with the customer 104 (alternatively, “customer computing device”). By way of example and not limitation, the local business computing devices 102 and the customer computing device 104 are shown communicatively coupled via a communication network 110.

Each of the business computing devices 102 and the customer computing device 104 may be embodied as a desktop, laptop, tablet, or even smartphone, computer that incorporates Wi-Fi, wired, or cellular telephone, functionality. Notably, the communications network 110 may use one or more of various communication types such as, for example and without limitation, wired, cellular and Wi-Fi communications. Moreover, each of the business computing devices 102 and the customer computing device 104 may be coupled to a power supply, which may be effectuated by way of a power cord, battery, and/or other means of supplying electrical power as may be available or otherwise desired.

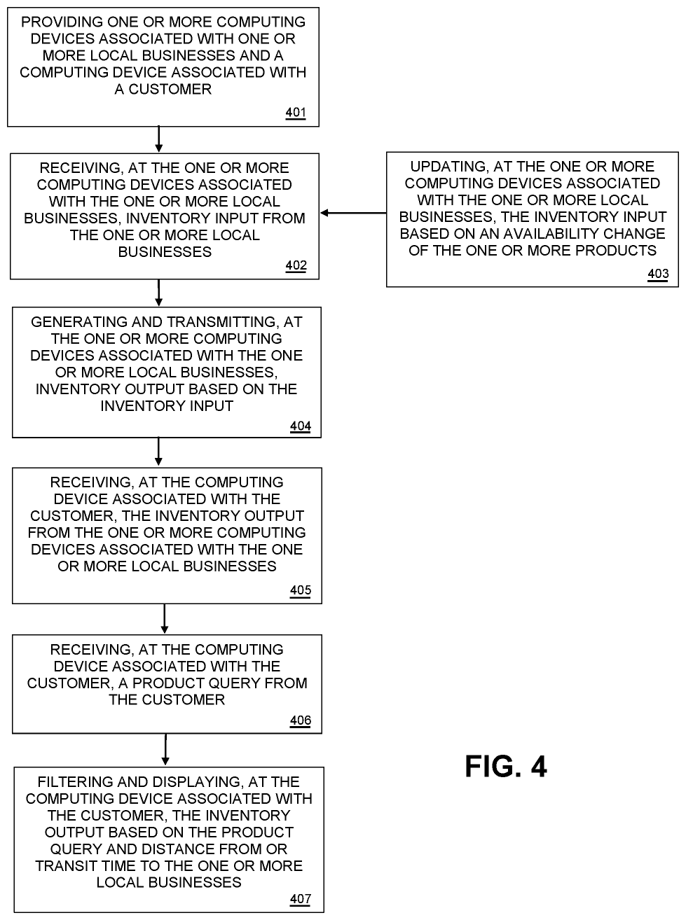

The local business computing devices 102 and the customer computing device 104 may become members of a network that enables each to interact with one another and exchange information, such as information regarding the one or more products or one or more service hours offered by the one or more local businesses. In this exemplary embodiment, the network may be facilitated by a website that is hosted by a network server. As such, the server may facilitate interaction among a limited group of members, as may be established by the members themselves. For the purpose of the example presented in FIG. 1, the limited group of members may include the business computing devices 102 and the customer computing device 104. Additionally, server may implement the system for local business inventories aggregation and facilitate sharing information relating to the one or more products and the customer's product queries, or information relating to the one or more service hours and the customer's service queries. Specifically, the server may implement the steps outlined in FIG. 4. Accordingly, members of the network 110 may access the server using their devices 102 and 104 to obtain information, input information, and receive notifications, such as text messages and push notifications regarding product or service reservations and product or service availability.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the computing devices 102, 104. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

According to certain embodiments, the one or more computing devices associated with the one or more local businesses 102 may be operative to receive inventory input from the one or more local businesses. The inventory input may comprise the one or more products available at each of the one or more local businesses. Alternatively, the inventory input may comprise the one or more service hours available at each of the one or more local businesses. In some embodiments, the inventory input may comprise all products or service hours available at or from one or more of the one or more local businesses while, in others, the inventory input may only comprise some of the products or service hours available at or from the one or more local businesses.

Moreover, the inventory input may comprise a specified amount of each of the one or products or one or more service hours available at the local businesses. Alternatively, the inventory input may comprise an estimated amount of each of the one or more products or one or more service hours available at the local businesses. For instance, the estimated amount may be based on previous sales of the one or more products or known restocking dates of the one or more products. The estimated amount may also be based on previous sales of the one or more products on that particular day. In addition, the estimated amount may be based on a season and, therefore, concomitant demand for one or more of the one or more products during that season.

Based on the specified amount of the one or more products or the one or more service hours available at each of the one or more local businesses, the local business computing devices 102 may be further operative to track and update a business reliability score. The business reliability score may reflect whether the one or more local businesses has accurately or inaccurately updated the specified amount. The business reliability score may be higher if the one or more local businesses has consistently updated the specified amount in an accurate manner. By contrast, the business reliability score may be lower if the one or more local businesses has failed to consistently update the specified amount. Additionally, the business reliability score may be lower if the one or more local businesses has consistently updated the specified amount in an inaccurate manner. In this manner, the customer computing devices 104 may be operative to track and update the business reliability score. In particular, the customer may manually input an availability score based on whether the specified amount of the one or more products or one or more service hours were indeed available at the one or more local businesses. In turn, the business reliability score may be updated based on the availability score.

The customer computing devices 104 may then be operative to filter the one or more products or the one or more service hours based on the business reliability score. Indeed, filtering the one or more products or the one or more service hours based on the business reliability score may comprise filtering the one or more products or the one or more service hours if the business reliability score falls below a predetermined threshold. In other embodiments, the customer may determine a threshold for the business reliability score in this manner.

The local business computing devices 102 may also be operative to update the inventory input based on an availability change of the one or more products or the one or more service hours. The availability change may be manually inputted by the local businesses. Otherwise, the availability change may be updated automatically when the customer, or another customer, purchases or reserves one or more of the one or more products or the one or more service hours, as discussed in greater detail below. In still other embodiments, the availability change may be based on the estimated amount of the one or more products or the one or more service hours based on previous sales or known restocking dates. Based on the inventory input, the business computing devices 102 may be operative to generate and transmit inventory output.

In certain embodiments, the customer computing device 104 may be operative to receive the inventory output from the local business computing devices 102 and receive a product query or a service query from the customer. The product query may comprise one or more products needed or desired by the customer in a time-sensitive manner. Similarly, the service query may comprise one or more services needed by the customer in a time-sensitive manner. The customer computing device 104 may also be operative to generate and display one or more similar products. The one or more similar products may be based on previous customer product queries or one or more customer preferences. Alternatively, the one or more similar products may be based on one or more anticipated product queries, such as a product which may be predicted to run out on a given date. For instance, the one or more anticipated product queries may comprise cosmetics or food items, both of which have a finite amount of use.

In some embodiments, the customer computing device 104 may be operative to display a menu comprising all available products at one or more of the one or more local businesses. In this manner, the customer may browse all available products prior to selecting a specific product. In such embodiments, the inventory input received by the local business computing devices 102 may comprise all available products or service hours at one or more of the one or more local businesses.

Based on the product query or the service query, and distance from or transit time to the one or more local businesses, the computing device associated with the customer 104 may also be operative to filter and display the inventory output. In accordance with some embodiments, a combination of both the distance from and the transit time to the one or more local businesses may be filtered so as to provide the customer with the one or more products at the one or more local businesses which may be closest to the customer. Alternatively, the customer may select whether to filter based on the transit time or the distance from the one or more local businesses. In further embodiments, the customer computing device 104 may also be operative to filter and display the inventory output based on the estimated amount so long as the estimated amount exceeds a predetermined threshold. The predetermined threshold may be automatically set, set by the local business, or even, set by the customer.

In further embodiments, the business computing devices 102 may also be operative to receive a position input. The position input may be based on a position of the one or more products within the one or more local businesses. For instance, the position input may comprise a map of the local businesses or a written description and/or instructions for how to locate the one or more products within the local businesses. Based on the position input, the local business computing devices 102 may then be operative to generate and transmit position output. The customer computing device 104 may thereby be further operative to receive and display the position output. The position output may similarly comprise a map and/or a written description and/or instructions for how to locate the one or more products within the local businesses.

In still further embodiments, the customer computing device 104 may be operative to receive one or more product reservations. The one or more product reservations may comprise at least one of the one or more products at the one or more local businesses. The customer computing device 104 may also receive identity information associated with the customer and payment information associated with the customer. The identity information may comprise identifying information associated with the customer, such as name and address. The payment information may comprise credit card information, bank account information, or an intention for cash payment. Then, the customer computing device 104 may be operative to transmit the one or more product reservations, the identity information, and the payment information.

In such embodiments, the business computing devices 102 may be further operative to receive the one or more product reservations, the identity information, and the payment information. The business computing devices 102 may be operative to notify the local business of the one or more product reservations, the identity information, and the payment information.

In some of these embodiments, the local business computing devices 102 may be operative to receive a fulfillment input or an unavailability input from the one or more local businesses. The fulfillment input may indicate that the one or more products have been reserved for the customer. The unavailability input may indicate that the one or more products are unavailable at the one or more local businesses. Responsive to the unavailability input, the local business computing devices 102 may be operative to generate and transmit an unavailability output. The customer computing device 104 may then be operative to receive the unavailability output and notify the customer of the unavailability output.

Further, the customer computing device 104 may be operative to display one or more alternative products. The one or more alternative products may be available at the one or more local businesses. In addition, the one or more alternative products may comprise one or more products which serve the same purpose as those which were unavailable. The one or more alternative products may also comprise an identical type of product having a different brand.

In additional embodiments, the customer computing device 104 may also be operative to track and update a customer reliability score. The customer reliability score may be tracked and updated responsive to the customer computing device 104 receiving and transmitting the one or more product reservations. For example, if the customer fails to retrieve the one or more products from the one or more local businesses within an allotted time frame after making the one or more product reservations, the customer reliability score may be lower. On the other hand, if the customer consistently retrieves the one or more products within the allotted time frame, the customer reliability score may be higher.

In these embodiments, the business computing devices 102 may also be operative to track and update the customer reliability score. For instance, the one or more local businesses may manually input a reservation score. The reservation score may be based on whether the customer retrieved the one or more products reserved under the one or more product reservations. In this manner, the customer reliability score may then be updated.

The business computing devices 102 may be further operative to receive the customer reliability score. The business computing devices 102 may then be operative to display the customer reliability score. Moreover, in some embodiments, the business computing devices 102 may be operative to filter the one or more product reservations based on the customer reliability score. Indeed, if the customer's customer reliability score falls below a predetermined threshold or a threshold set by the one or more local businesses, the one or more local businesses may choose to cancel the one or more product reservations.

In accordance with further embodiments, the business computing devices 102 may be further operative to receive a demand input. In some embodiments, the demand input may correspond to an increased demand for one or more of the one or more products. In other embodiments, the demand input may correspond to an increased demand for one or more of the one or more service hours. The local business computing devices 102 may also be operative to generate and transmit a demand notification based on the demand input. The one or more local businesses may then be able to increase production of the one or more products to meet the increased demand. Alternatively, in embodiments wherein the demand input corresponds to the one or more service hours, the local businesses may be able to hire additional employees or contractors or expand available service hours to meet the increased demand.

In still further embodiments, the business computing devices 102 may also be operative to dynamically price the one or more products or the one or more service hours. For example, if the one or more products have not been purchased within a predetermined time period, it may be desirable for the one or more products to be priced lower so as to encourage sale thereof. By way of further example, the predetermined time period may be based on an expiration date of the one or more products. Similarly, if the one or more service hours have not been booked within the predetermined time period, it may be desirable for the one or more service hours to be priced lower so as to encourage booking thereof.

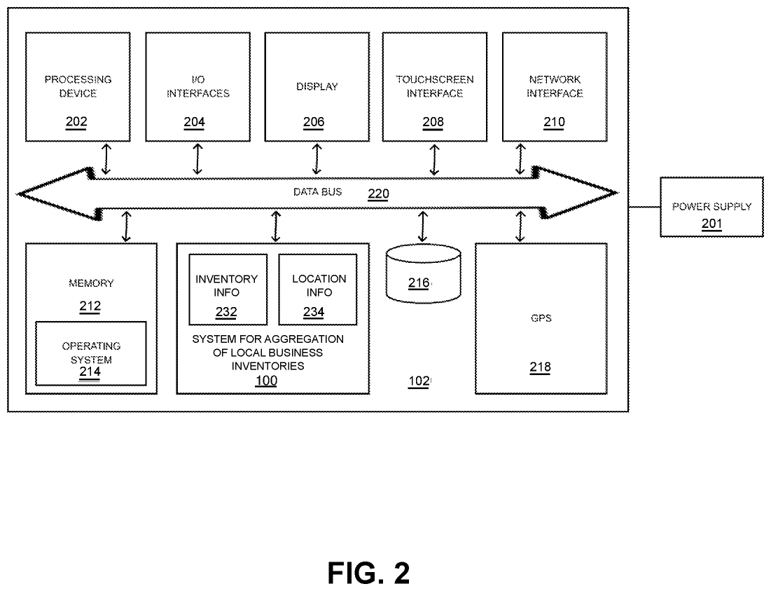

FIG. 2 illustrates the one or more computing devices associated with the one or more local businesses 102 shown in FIG. 1. As described earlier, the business computing devices 102 may be a tablet computer, laptop computer, desktop computer, or smartphone but may also be embodied in any one of a wide variety of wired and/or wireless computing devices. As shown in FIG. 2, the local business computing devices 102 may a processing device (processor) 202, input/output interfaces 204, a display 206, a touchscreen interface 208, a network interface 210, a memory 212, and operating system 214, a mass storage 216 and an GPS 218, with each communicating across a local data bus 220. Additionally, the business computing devices 102 may incorporate a system for aggregation of local business inventories 100, which is depicted as including inventory information 232 and location information 234 although the location of information 232, 234 may vary. The business computing devices 102 may further comprise a power supply 201.

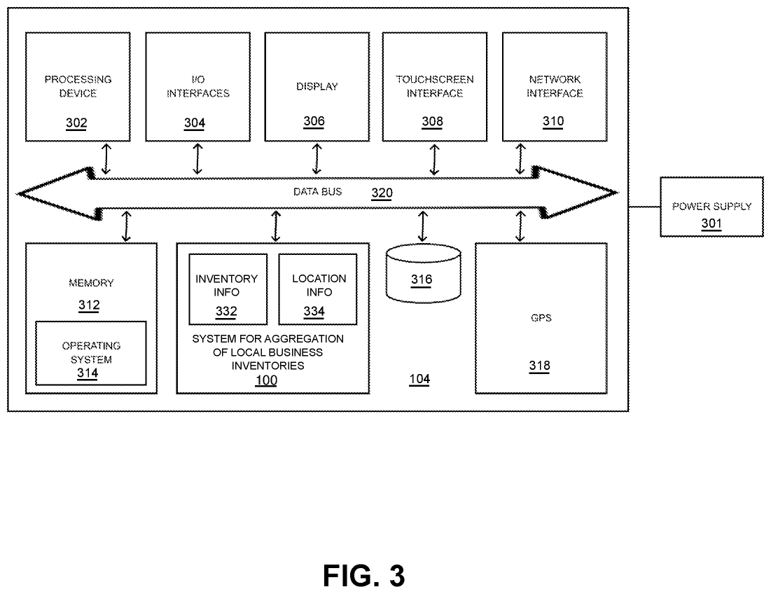

FIG. 3 illustrates the customer computing device 104 shown in FIG. 1. As described earlier, the customer computing device 104 may be a laptop computer, desktop computer, tablet computer or smartphone but may also be embodied in any one of a wide variety of wired and/or wireless computing devices. As shown in FIG. 3, the customer computing device 104 may include a processing device (processor) 302, input/output interfaces 304, a display 306, a touchscreen interface 308, a network interface 310, a memory 312, and operating system 314, a mass storage 316 and an GPS 318, with each communicating across a local data bus 320. Additionally, the customer computing device 104 may incorporate a system for aggregation of local business inventories 100, which is depicted as including inventory information 332 and location information 334, although the location of information 332, 334 may vary. The customer computing device 104 may further comprise a power supply 301.

As shown in FIGS. 2-3, processing device 202, 302 may include any custom made or commercially available processor, a central processing unit (CPU) or an auxiliary processor among several processors associated with the local business computing devices 102 and the customer computing device 104, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

Memory 212, 312 may include any one of a combination of volatile memory elements (e.g., random-access memory (RAM, such as DRAM, and SRAM, etc.)) and nonvolatile memory elements. The memory may typically comprise native operating system 214, 314, one or more native applications, emulation systems, or emulated applications for any of a variety of operating systems and/or emulated hardware platforms, emulated operating systems, etc. For example, the applications may include application specific software which may comprise some or all the components of the local business computing devices 102 and the customer computing device 104. In accordance with such embodiments, the components are stored in memory and executed by the processing device. Note that although depicted separately in FIGS. 2-3, the system and method for aggregation of local business inventories 100 may be resident in memory, such as memory 212, 312.

Touchscreen interface 208, 308 may be configured to detect contact within the display area of the display 206, 306 and may provide such functionality as on-screen buttons, menus, keyboards, etc. that allows users to navigate user interfaces by touch. For some embodiments, the local business computing devices 102 and the customer computing device 104 may comprise GPS 318 or other means to determine the location of the devices 102, 104.

One of ordinary skill in the art will appreciate that memory 214, 314 may, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIGS. 2-3, network interface device 210, 310 may comprise various components used to transmit and/or receive data over a networked environment such as depicted in FIG. 1. When such components are embodied as an application, the one or more components may be stored on a non-transitory computer-readable medium and executed by the processing device.

FIG. 4 is a flowchart depicting an exemplary embodiment of a system and method for aggregation of local business inventories such as may be performed by the local business computing devices 102 and the customer computing device 104 of FIGS. 1-3. While, as discussed throughout this disclosure, the inventory input may comprise one or more products or one or more service hours, FIG. 4 depicts an embodiment comprising the one or more products. As shown in FIG. 4, the method may include the steps of: providing one or more computing devices associated with one or more local businesses and a computing device associated with a customer (block 401); receiving, at the one or more computing devices associated with the one or more local businesses, inventory input from the one or more local businesses, wherein the inventory input is associated with one or more products available at the one or more local businesses (block 402); updating, at the one or more computing devices associated with the one or more local businesses, the inventory input based on an availability change of the one or more products (block 403); generating and transmitting, at the one or more computing devices associated with the one or more local businesses, inventory output based on the inventory input (block 404); receiving, at the computing device associated with the customer, the inventory output from the one or more computing devices associated with the one or more local businesses (block 405); receiving, at the computing device associated with the customer, a product query or a service query from the customer (block 406); and filtering and displaying, at the computing device associated with the customer, the inventory output based on the product query or the service query, and distance from or transit time to the one or more local businesses (block 407).

According to certain further embodiments, the computer-implemented method may also comprise the step of: displaying, at the computing device associated with the customer, a menu comprising all available products at one or more of the one or more local businesses. In such embodiments, the menu may be useful if the customer has not yet selected a specific product but rather, desires to browse the one or more local businesses' entire inventories of products. Additionally, the method may further comprise the step of: generating and displaying, at the computing device associated with the customer, one or more similar products based on one or more customer preferences or one or more anticipated product queries.

In accordance with additional embodiments, the method may comprise the further steps of: receiving, at the one or more computing devices associated with the one or more local businesses, a position input based on a position of the one or more products within the one or more local businesses; generating and transmitting, at the one or more computing devices associated with the one or more local businesses, position output based on the position input; and receiving and displaying, at the computing device associated with the customer, the position output. These further steps may further expedite the customer's retrieval of the one or more products within the local business.

In still further embodiments, the computer-implemented method may further comprise the steps of: receiving, at the computing device associated with the customer, one or more product reservations comprising at least one of the one or more products at the one or more local businesses; receiving, at the computing device associated with the customer, identity information and payment information associated with the customer; transmitting, at the computing device associated with the customer, the one or more product reservations, payment information, and identity information; receiving, at the one or more computing devices associated with the one or more local businesses, the one or more product reservations; notifying, at the one or more computing devices associated with the one or more local businesses, the one or more local businesses of the one or more product reservations; and receiving, at the one or more computing devices associated with the one or more local businesses, a fulfillment input from the one or more local businesses indicating the one or more products have been reserved for the customer.

In embodiments where the one or more products may be unavailable at the local business after the computing device associated with the customer has received the one or more product reservations, the method may alternatively comprise the steps of: receiving, at the one or more computing devices associated with the one or more local businesses, an unavailability input from the one or more local businesses indicating the one or more products is unavailable; generating and transmitting, at the one or more computing devices associated with the one or more local businesses, an unavailability output based on the unavailability input; receiving, at the computing device associated with the customer, the unavailability output; notifying, at the computing device associated with the customer, the customer of the unavailability output; and displaying, at the computing device associated with the customer, one or more alternative products available at one or more of the one or more local businesses.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the local business may offer goods, services, or even, rental of goods. As another example, the customer may be an individual or a third-party delivery service. Accordingly, it is intended that the invention not be limited, except as by the appended claims.

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for aggregation of local business inventories with which that terminology is associated. In general, the terms used in the following claims should not be constructed to limit the system and method for aggregation of local business inventories to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for aggregation of local business inventories is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for aggregation of local business inventories.

What is claimed is:

1. A system for aggregation of local business inventories, comprising
one or more computing devices associated with one or more local businesses, operative to receive inventory input from the one or more local businesses, wherein the inventory input is associated with one or more products or one or more service hours available at the one or more local businesses;
update the inventory input based on an availability change of the one or more products or the one or more service hours;
generate and transmit inventory output based on the inventory input;
a computing device associated with a customer, operative to
receive the inventory output from the one or more computing devices associated with the one or more local businesses;
receive a product query or a service query from the customer; and
filter and display the inventory output based on the product query or the service query, and distance from or transit time to the one or more local businesses.

2. The system of claim 1, wherein the inventory input further comprises a specified amount of the one or more products or the one or more service hours available at each of the one or more local businesses.

3. The system of claim 1, wherein the inventory input further comprises an estimated amount of the one or more products or the one or more service hours available at each of the one or more local businesses.

4. The system of claim 3, wherein the computing device associated with the customer is operative to display the inventory output if the estimated amount of the one or more products or the one or more service hours available at each of the one or more local businesses is greater than a predetermined threshold.

5. The system of claim 1, wherein the inventory input comprises all available products or service hours at the one or more local businesses.

6. The system of claim 5, wherein the computing device associated with the customer is further operative to
display a menu comprising all available products or service hours at one or more of the one or more local businesses.

7. The system of claim 1, wherein
the one or more computing devices associated with the one or more local businesses is further operative to
receive a position input based on a position of the one or more products within the one or more local businesses;
generate and transmit position output based on the position input; and
the computing device associated with the customer is further operative to
receive and display the position output.

8. The system of claim 1, wherein
the computing device associated with the customer is further operative to
receive one or more product reservations comprising at least one of the one or more products at the one or more local businesses;
receive identity information and payment information associated with the customer;
transmit the one or more product reservations, the payment information, and the identity information;
the one or more computing devices associated with the one or more local businesses is further operative to
receive the one or more product reservations, the payment information, and the identity information;
notify the one or more local businesses of the one or more product reservations; and
receive a fulfillment input from the one or more local businesses indicating the one or more products have been reserved for the customer; and
receive an unavailability input from the one or more local businesses indicating the one or more products is unavailable.

9. The system of claim 8, wherein
the one or more computing devices associated with the one or more local businesses is further operative to
generate and transmit an unavailability output based on the unavailability input;
the computing device associated with the customer is further operative to
receive the unavailability output;
notify the customer of the unavailability output; and
display one or more alternative products available at one or more of the one or more local businesses.

10. The system of claim 1, wherein the computing device associated with the customer is further operative to generate and display one or more similar products based on one or more customer preferences or one or more anticipated product queries.

11. A method for aggregation of local business inventories, comprising
providing one or more computing devices associated with one or more local businesses and a computing device associated with a customer;
at the one or more computing devices associated with the one or more local businesses,
receiving inventory input from the one or more businesses, wherein the inventory input is associated with one or more products or one or more service hours available at the one or more local businesses;
updating the inventory input based on an availability change of the one or more products or the one or more service hours;
generating and transmitting inventory output based on the inventory input;
at the computing device associated with the customer,
receiving the inventory output from the one or more computing devices associated with the one or more local businesses;
receiving a product query or a service query from the customer; and
filtering and displaying the inventory output based on the product query or the service query, and distance from or transit time to the one or more local businesses.

12. The method of claim 11, further comprising
at the computing device associated with the customer,
displaying a menu comprising the all available products or service hours at one or more of the one or more local businesses.

13. The method of claim 11, further comprising
at the one or more computing devices associated with the one or more local businesses,
receiving a position input based on a position of the one or more products within the one or more local businesses;
generating and transmitting position output based on the position input; and
at the computing device associated with the customer,
receiving and displaying the position output.

14. The method of claim 11, further comprising
at the computing device associated with the customer,
receiving one or more product reservations comprising at least one of the one or more products at the one or more local businesses;
receiving identity information and payment information associated with the customer;
transmitting the one or more product reservations, payment information, and identity information;
at the one or more computing devices associated with the one or more local businesses,
receiving the one or more product reservations;
notifying the one or more local businesses of the one or more product reservations; and
receiving a fulfillment input from the one or more local businesses indicating the one or more products have been reserved for the customer.

15. The method of claim 14, further comprising
at the one or more computing devices associated with the one or more local businesses,
receiving an unavailability input from the one or more local businesses indicating the one or more products is unavailable;
generating and transmitting an unavailability output based on the unavailability input;
at the computing device associated with the customer,
receiving the unavailability output;
notifying the customer of the unavailability output; and
displaying one or more alternative products available at one or more of the one or more local businesses.

16. The method of claim 11, further comprising
at the computing device associated with the customer,
generating and displaying one or more similar products based on one or more customer preferences or one or more anticipated product queries.

17. A non-transitory, tangible computer-readable medium having stored thereon computer-executable instructions, which, when executed by a computer processor, enable performance of a method comprising:
providing one or more computing devices associated with one or more local businesses and a computing device associated with a customer;
receiving, at the one or more computing devices associated with the one or more local businesses, inventory input from the one or more businesses, wherein the inventory input is associated with one or more products or one or more service hours available at the one or more local businesses;
updating, at the one or more computing devices associated with the one or more local businesses, the inventory input based on an availability change of the one or more products or the one or more service hours;
generating and transmitting, at the one or more computing devices associated with the one or more local businesses, inventory output based on the inventory input;
receiving, at the computing device associated with the customer, the inventory output from the one or more computing devices associated with the one or more local businesses;
receiving, at the computing device associated with the customer, a product query or a service query from the customer; and
filtering and displaying, at the computing device associated with the customer, the inventory output based on the product query or the service query, and distance from or transit time to the one or more local businesses.

18. The medium of claim 17, wherein the inventory input further comprises a specified amount or an estimated amount of the one or more products or the one or more service hours available at each of the one or more local businesses.

19. The medium of claim 17, wherein the method further comprises
receiving, at the one or more computing devices associated with the one or more local businesses, a position input based on a position of the one or more products within the one or more local businesses;
generating and transmitting, at the one or more computing devices associated with the one or more local businesses, position output based on the position input; and
receiving and displaying, at the computing device associated with the customer, the position output.

20. The medium of claim 17, wherein the method further comprises
receiving, at the computing device associated with the customer, one or more product reservations comprising at least one of the one or more products at the one or more local businesses;
receiving, at the computing device associated with the customer, identity information and payment information associated with the customer;
transmitting, at the computing device associated with the customer, the one or more product reservations, payment information, and identity information;
receiving, at the one or more computing devices associated with the one or more local businesses, the one or more product reservations;
notifying, at the one or more computing devices associated with the one or more local businesses, the one or more local businesses of the one or more product reservations; and
receiving, at the one or more computing devices associated with the one or more local businesses, a fulfillment input from the one or more local businesses indicating the one or more products have been reserved for the customer or an unavailability input from the one or more local businesses indicating the one or more products is unavailable.
